(19) United States
(12) Patent Application Publication
(10) Pub. No.: US 2023/0046410 A1
(43) Pub. Date: Feb. 16, 2023

(54) SEMANTIC ANNOTATION OF SENSOR DATA USING UNRELIABLE MAP ANNOTATION INPUTS

(71) Applicant: Motional AD LLC, Boston, MA (US)

(72) Inventors: Sergi Adipraja Widjaja, Singapore (SG); Venice Erin Baylon Liong, Singapore (SG); Bartolomeo Della Corte, Singapore (SG)

(21) Appl. No.: 17/444,819

(22) Filed: Aug. 10, 2021

(51) Int. Cl. G06K 9/62; G06K 9/00; G06T 7/246; G06N 20/00

(52) U.S. Cl. CPC G06K 9/6262; G06K 9/00651; G06K 9/6257; G06N 20/00; G06T 7/251; G06K 9/00798; G06K 9/00818; G06K 9/00825; G06T 2207/20084

(57) ABSTRACT

Provided are methods for semantic annotation of sensor data using unreliable map annotation inputs, which can include training a machine learning model to accept inputs including images representing sensor data for a geographic area and unreliable semantic annotations for the geographic area. The machine learning model can be trained against validated semantic annotations for the geographic area, such that subsequent to training, additional images representing sensor data and additional unreliable semantic annotations can be passed through the neural network to provide predicted semantic annotations for the additional images. Systems and computer program products are also provided.

### BACKGROUND

Self-driving vehicles typically use multiple types of images to perceive the area around them. Training these systems to accurately perceive an area can be difficult and complicated.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is a block diagram illustrating an example of a training system for generating a trained machine learning model to produce predicted semantic annotations for an area based on sensor data and unvalidated annotations for the area.

FIG. 6 is a block diagram illustrating an example of a perception system using a trained machine learning model to produce predicted semantic annotations for an area based on sensor data and unvalidated annotations for the area.

FIG. 7 is flowchart depict an example routine for generating a trained machine learning model to produce predicted semantic annotations for an area based on sensor data and unvalidated annotations for the area.

FIG. 8 is flowchart depict an example routine for using a trained machine learning model to produce predicted semantic annotations for an area based on sensor data and unvalidated annotations for the area.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. Also, the term “or” is used in its inclusive sense (and not in its exclusive sense) so that when used, for example, to connect a list of elements, the term “or” means one, some, or all of the elements in the list. Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be openended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

In some aspects and/or embodiments, systems, methods, and computer program products described herein include and/or implement semantic annotation of sensor data using unreliable map annotation inputs. Generally described, semantic annotation adds semantic understanding to sensor data, representing the meaning and context of that sensor data. Semantic understanding, in turn, enables a machine to process and interpret the sensor data as a human might. Accordingly, semantic understanding represents a specific type of “computer vision”—a field of technology that attempts to enable computers to “see” the world in a manner similar to a human being. For example, sensor data may represent an image of a geographic area around a vehicle, such as a birds-eye map or a street-level view. Semantic annotations may designate certain portions of that image as representing physical features within the area around the vehicle, such as by designating areas as a traffic lane (e.g., a drivable surface for motorized vehicles, for bikes, etc.), a cross walk, an intersection, a traffic signal, a traffic sign, etc. As can be readily appreciated, semantic understanding of physical features within sensor data can be of very high importance for a number of tasks, such as programmatic navigation of the area (e.g., to implement a self-driving vehicle). As discussed in more detail below, the present disclosure relates to an improvement in generating semantic understanding for sensor data, enabling use of unreliable annotations to generate that semantic understanding.

One mechanism for providing semantic understanding is manual markup. Sensor data for a given area can be captured and then passed to a human operator. The human operator can then manually mark up images generated from the sensor data of an area to specify particular physical features captured in the images. On next entering the area, a device can capture sensor data and detect the physical features based on similarities to the previously captured sensor data and on the prior markups. Assuming that skilled human operators are selected and sufficient quality control mechanisms are in place, manual markup can be highly accurate. Thus, devices may be configured to use manual markups as “ground truth”—that is, facts that can be generally assumed to be true, and need not be programmatically derived by the device.

A problem with manual markup is the difficulty of selecting skilled human operators and providing sufficient quality control mechanisms. As will be appreciated, the tolerance for error in data used as ground truth is often extremely low. For example, in the case of a self-driving vehicle, incorrect semantic understanding of a geographic area can lead to significant safety concerns, given the potential risk for bodily harm or loss of life. Thus, it is often extremely labor intensive to create sufficiently high quality markups for direct use as ground truth.

In some cases, unvalidated semantic annotations are available. For example, a variety of public data sets contain semantic annotations. However, these are often not validated to the level required for direct use as ground truth. In some cases, the data has been “crowd sourced”—gathered from a wide variety of potentially anonymous users, with little or no validation. This can lead to errors or inaccuracies in the data. Even when the data is not wholly inaccurate, it may be less accurate than is needed to serve as “ground truth.” For example, when navigating a motorized vehicle, it may be necessary to have ground truth information of a certain granularity (e.g., to know the location of an intersection within some threshold, such as on the scale of centimeters rather than meters). The data provided by large data sets, such as crowd sourced sets, may not be sufficiently accurate to meet this requirement. This data is thus typically not directly usable to provide semantic understanding for sensor data. Nevertheless, the amount of data in such unvalidated data sets can often greatly exceed the amount of data that is sufficiently vetted to be used to represent ground truth. It would thus be desirable to provide systems and methods to use unreliable semantic annotations to provide reliable semantic understanding of sensor data.

Embodiments of the present disclosure address the above-noted problems by enabling creation of semantic understanding of sensor data using unvalidated semantic annotations, such as those provided by public or crowd sourced unvalidated sets. More specifically, embodiments of the present disclosure relate to use of unreliable semantic annotations as inputs to a machine learning model, which is trained based on combinations of unvalidated semantic annotations and corresponding sensor data. As discussed in more detail below, the machine learning model can be trained against a labeled data set representing ground truth, such as sensor data manually created and annotated with highly reliable annotations. The machine learning model can thus be trained to take in sensor data of a geographic area and unvalidated semantic annotations for that area, and to output validated semantic annotations representing physical features of the area. These validated annotations can then be used to provide an accurate understanding of the area for purposes such as navigation of self-driving vehicles.

As used herein, the term “semantic annotation” is used to denote information that extends beyond sensor data to provide semantic understanding of at least a portion of that sensor data, thus providing for example a meaning or context of the data. Examples of semantic annotations are provided herein, such as information designating a portion of sensor data as a given physical feature. Embodiments of the present disclosure may be of use in self-driving vehicles. For that reason, some examples are provided herein of semantic annotations and physical features that may be of particular use to self-driving vehicles, such as crosswalks, traffic lanes, traffic signals, etc. However, embodiments of the present disclosure may additionally or alternatively be used to generate validated semantic understanding for other physical features or objects, such as the identification of cars, people, bicycles, etc. The term “sensor data,” as used herein, refers to data generated by or generally derivable from sensors (e.g., sensors from an autonomous system that is the same as or similar to autonomous system 202, described below) that reflect the physical world. For example, sensor data may refer to raw data (e.g., the bits generated by a sensor) or to data points, images, point cloud, etc., generated from such raw data. As an illustrative example, sensor data may refer to a “ground-level” or “street-level” image, such as an image directly captured by a camera, a point cloud generated from a LiDAR sensor, a “birds-eye view” image or map generated by movement of a sensor through a geographic area, or the like. In some instances, semantic annotations may be used to modify such images in a manner that identifies features of the images. For example, a semantic annotation may be represented as an “overlay” highlighting, bordering, or otherwise indicating a portion of an image showing a physical feature. In other instances, a semantic annotation may exist as distinct data from sensor data, such as an auxiliary data set that identifies portions of the sensor data (e.g., bounds within an image) capturing a physical feature.

As will be appreciated by one of skill in the art in light of the present disclosure, the embodiments disclosed herein improve the ability of computing systems, such as computing devices included within or supporting operation of self-driving vehicles, to generate validated semantic annotations of sensor data using unvalidated map annotation inputs. Moreover, the presently disclosed embodiments address technical problems inherent within computing systems; specifically, the difficulty of programmatically determining validity of input data. These technical problems are addressed by the various technical solutions described herein, including the use of a machine learning model trained to obtain sensor data and unvalidated semantic annotations for the sensor data, and to produce from the sensor data and unvalidated semantic annotations a set of validated semantic annotations. Thus, the present disclosure represents an improvement in computer vision systems and computing systems in general.

The foregoing aspects and many of the attendant advantages of this disclosure will become more readily appreciated as the same become better understood by reference to the following description, when taken in conjunction with the accompanying drawings.

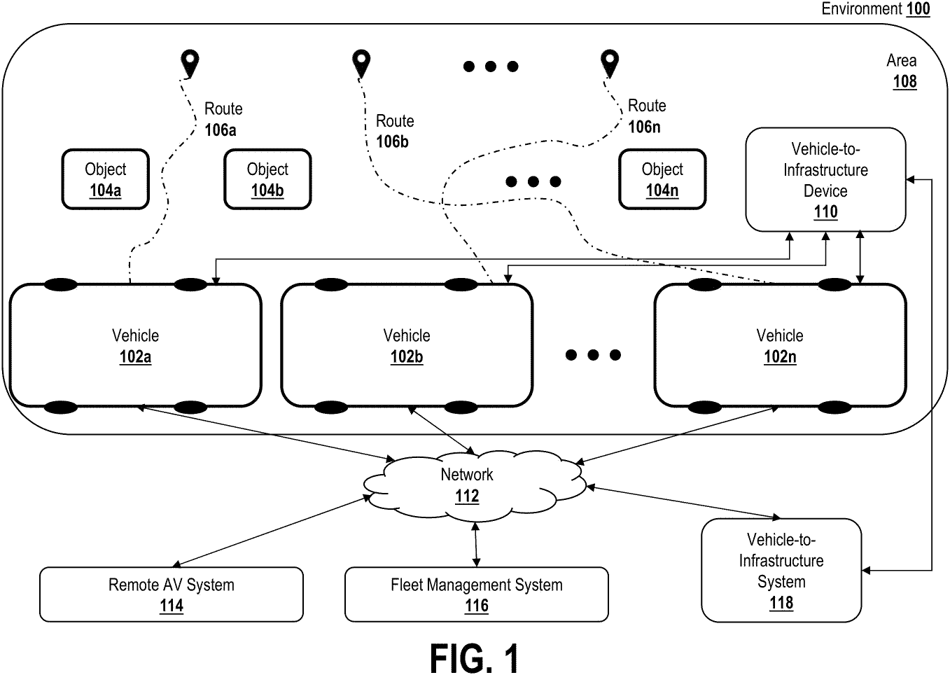

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

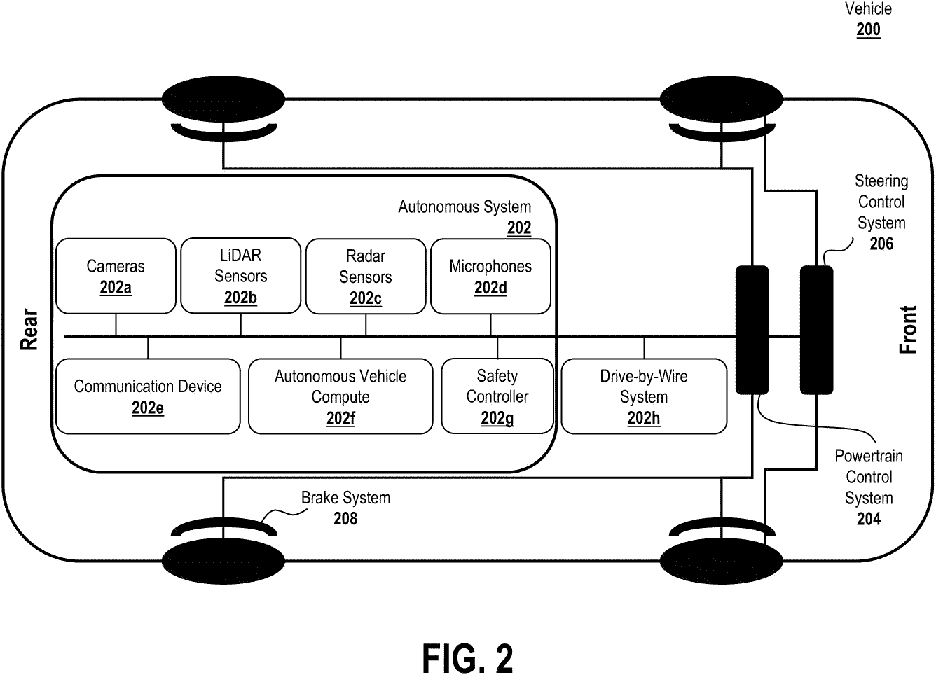

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like. Protocols and components for communicating via the Internet or any of the other aforementioned types of communication networks are known to those skilled in the art and, thus, are not described in more detail herein.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International’s standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

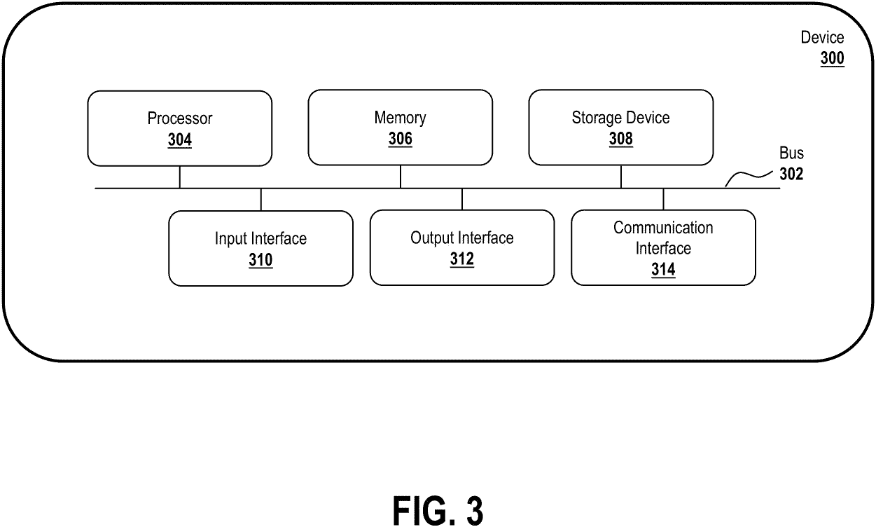

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

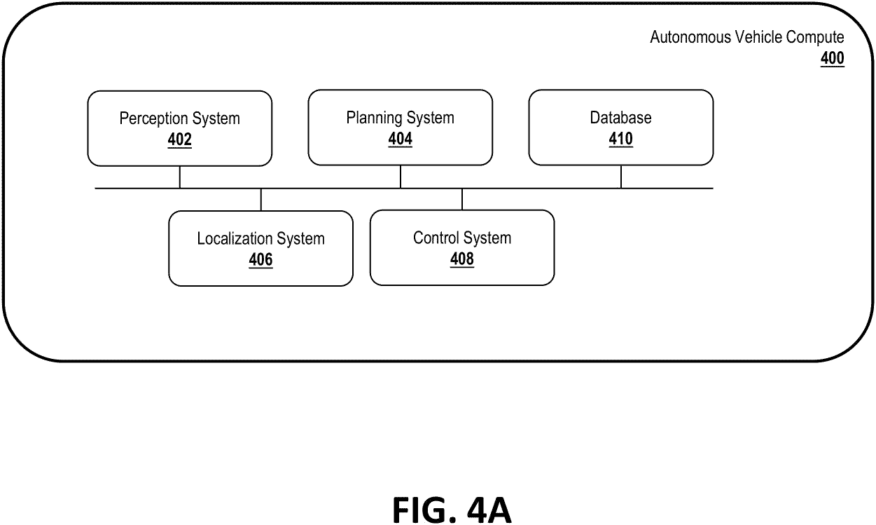

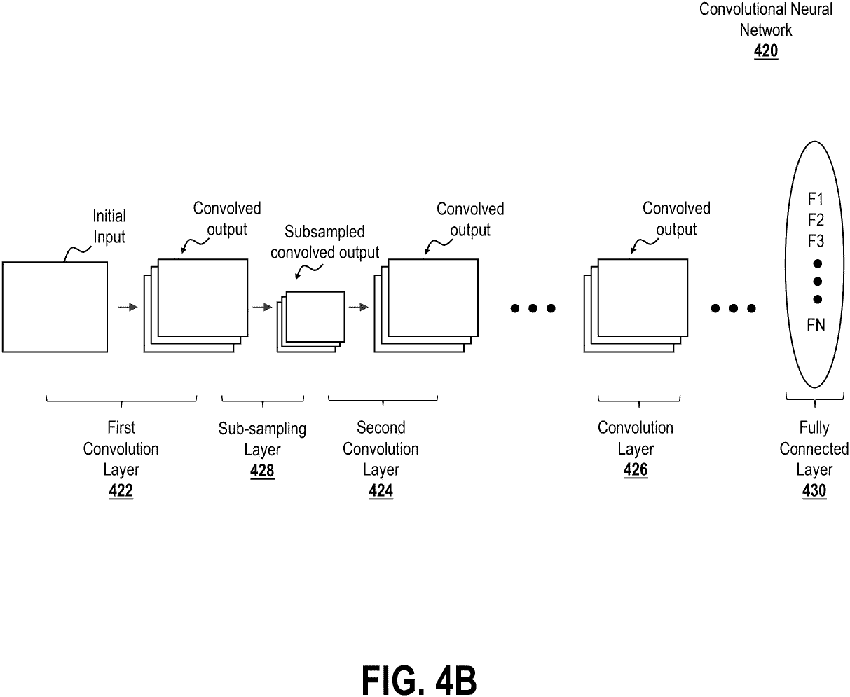

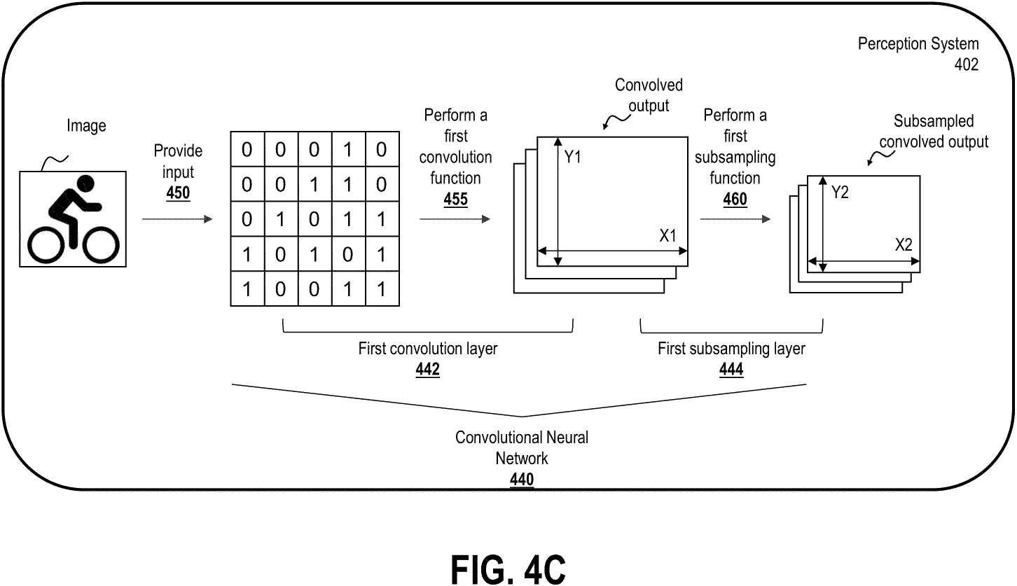

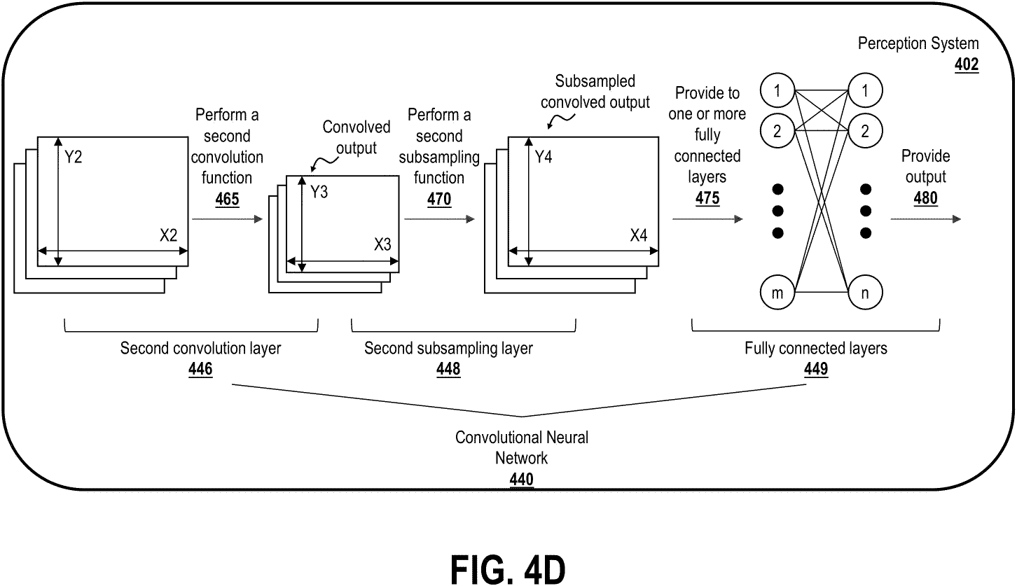

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

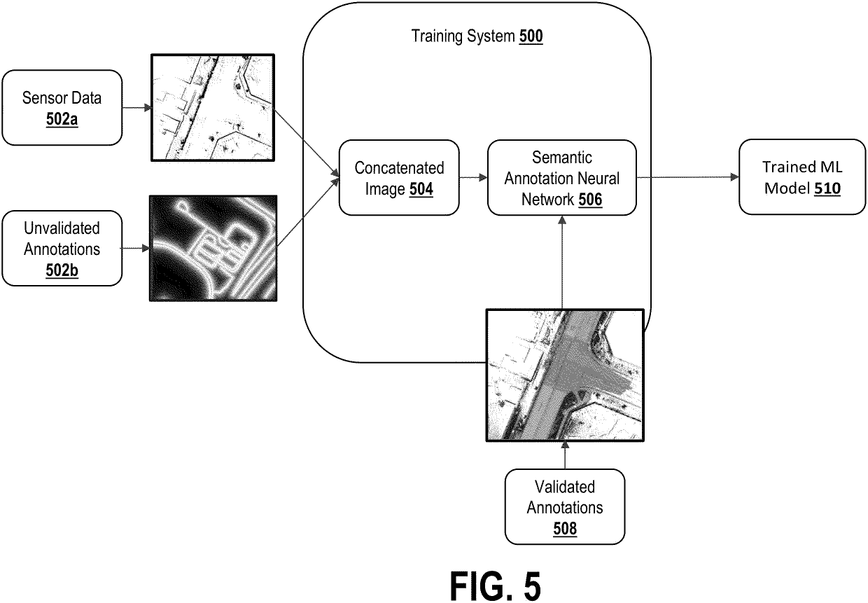

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D. Moreover, FIGS. 5-8 illustrate example interactions and routines for training and using a machine learning model in accordance with embodiments of the present disclosure to generate validated semantic annotations for sensor data from unvalidated semantic annotations.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 ... FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, ... FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

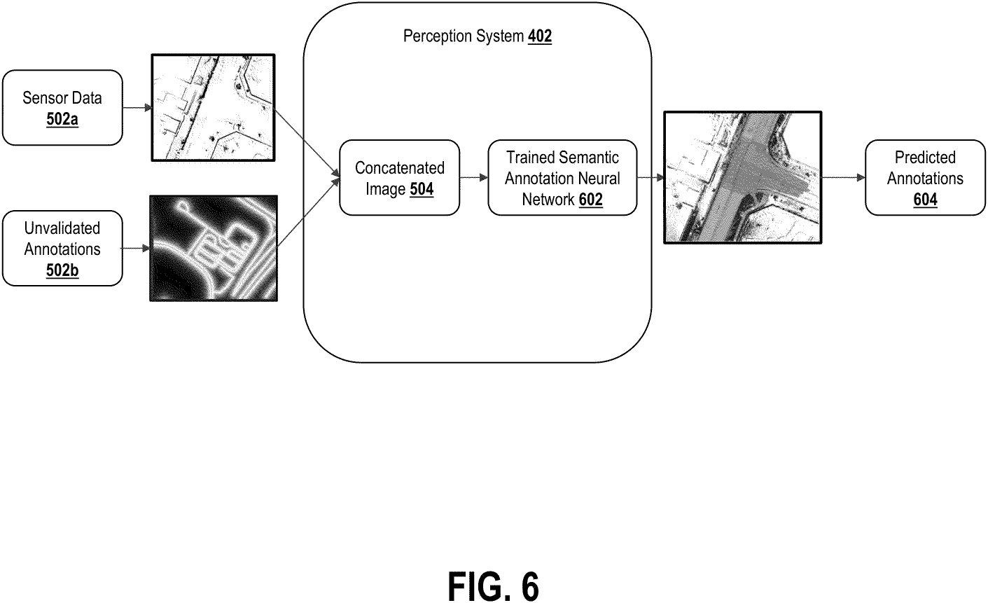

With reference to FIGS. 5 and 6, example interactions will be described for generating validated semantic annotations of sensor data using unvalidated semantic annotations. Specifically, FIG. 5 depicts illustrative interactions for training a machine learning (ML) model to generate validated semantic annotations, while FIG. 6 depicts illustrative interactions for using a trained ML model (such as that generated via the interactions of FIG. 5) to generate validated semantic annotations. Use of a trained ML model may also be referred to generally as an “inference” operation.

As shown in FIG. 5, generation of a trained ML model (which may also be referred to as “training” the ML model) may be conducted on a training system 500. The training system 500 illustratively represents a computing device, such as device 300. In some instances, the device 300 may be included within a vehicle 102. In other instances, the device 300 may be external to a vehicle 102. For example, the device 300 may be included within the network 112, remote AV system 114, fleet management system 116, etc. One skilled in the art will appreciate that training an ML model is often resource intensive but relatively time insensitive, and thus it may be preferable to conduct training on a device 300 with large amounts of computing resources. In one embodiment, the device 300 may be, for example, a virtual machine implemented at a cloud computing provider accessible via the network 112.

As shown in FIG. 5, the training system 500 obtains as inputs sensor data 502a of an area and unvalidated annotations 502b corresponding to that area. Sensor data can represent any data collected by or generally derived from real-world sensors, such as one or more of the devices of autonomous system 202, discussed above. In one embodiment, the sensor data is obtained as an image or other data projectable as an image, such as n-dimensional matrix of values. For example, the sensor data may represent a birds-eye view map or image of an area, a ground-level view of an area, a point cloud, etc. The unvalidated annotations 502b represent unvalidated semantic annotations of the area, such as indications of traffic lanes, intersections, traffic signals, and the like. In one embodiment, the unvalidated annotations 502b are obtained from a network-accessible repository of annotations, such as the Open Street Map project. The unvalidated annotations 502b may illustratively be represented as a graph. For example, traffic paths (e.g., streets, roads, etc.) may be represented as edges within the graph and intersections may be represented as nodes connecting such edges. Nodes and edges can be annotated with unvalidated annotations, such as a number of lanes in a road, or indication of whether a traffic signal at a given intersection is a traffic light, stop sign, etc. To facilitate processing via a machine learning model, unvalidated annotations obtained in the form of a graph can be transformed into image data prior to processing, such as by converting the graph into raster data corresponding to an image. For example, edges may be formed into a first image representing traffic paths, and nodes may be formed into a second image representing intersections. In other embodiments, the unvalidated annotations 502b may be obtained as annotated image data, and thus transformation into image data may be unnecessary.

In order to process sensor data 502a and unvalidated annotations 502b, the training system 500 is configured to concatenate the sensor data 502a and the unvalidated annotations 502b into a concatenated image 504. Illustratively, the sensor data 502a may be represented as set of aligned 2-dimensional matrixes, with each such matrix representing a layer of an image. For example, a color image may be represented in 3 channels, each corresponding to values of a respective primary color that, when combined, result in an image. A greyscale image may be represented as a single matrix, with values within the matrix representing the darkness of a pixel in the image. To provide annotations for the image, the concatenated image 504 can add one or more additional layers to the sensor data 502a, each such layer representing all or a portion of unvalidated annotations. For example, one layer may be added to the sensor data 502a that indicates whether each location in the matrix (e.g., each “pixel”) corresponds to an intersection (e.g., via concatenation of an image showing nodes in a graph of roads), a second layer can be added that indicates whether each location corresponds to a traffic path (e.g., via concatenation of an image showing edges in the graph), a third layer can be added that indicates whether each location corresponds to a crosswalk, etc.

In some instances, the system 500 may conduct alignment, pre-processing, or pre-validation prior to such concatenation. For example, in order to ensure that correct alignment occurs between sensor data 502a and unvalidated annotations 502b, the system 500 may compare location information of the sensor data 502a and the annotations 502b in order to validate that both correspond to the same area. Illustratively, GPS data may be associated with the sensor data 502a and annotations 502b respectively to indicate bounds of a geographic area represented in the data 502a and annotations 502b (e.g., as a set of coordinates, scale information, etc.). The system 500 may thus compare such GPS data to ensure that both inputs are aligned prior to concatenation. In some instances, the system 500 may crop either or both inputs to ensure correct alignment. Furthermore, in some embodiments the system 500 may validate that the inputs are aligned, such as by ensuring a minimum overlap in data commonly represented in both inputs. For example, the system 500 may be configured to identify traffic paths in the sensor data 502a by applying edge detection to the sensor data 502a, and may be configured to validate alignment of that data 502a with the annotations 502b on the basis of comparing traffic paths in sensor data 502a to traffic paths identified in the annotations 502b. The system 500 can illustratively confirm alignment when a threshold proportion of traffic paths within one input are also represented in the other input. Still further, in some embodiments the system 500 conducts pre-processing on one or both inputs. For example, the system 500 may apply geometric manipulations, such as blurring or distance map operations, to images representing the unvalidated annotations to ensure that features such as traffic paths are sufficiently represented in the annotations 502b.

While examples above are given in which unvalidated annotations 502b are concatenated as a new layer onto sensor data 502a, in some embodiments the unvalidated annotations 502b and sensor data 502a may have different dimensions, the unvalidated annotations may have different dimensions than the sensor data 502a, or the unvalidated annotations may be dimensionless. For example, the sensor data 502a may represents a ground-level image on a given traffic path, and the unvalidated annotations 502b may indicate a number of lanes in that path, a traffic type for each lane or the path generally, etc. (e.g., without specifically identifying what portion of the sensor data 502a corresponds to which lane or type of lane). In such cases, it may not be necessary to represent unvalidated annotations 502b as an additional layer, and these annotations may be passed, for example, as metadata for the sensor data 502a. In other such cases, the system 500 may transform one or both of the sensor data 502a and the unvalidated annotations 502b such that they share common dimensionality and perspective. For example, where the sensor data 502a is a three-dimensional LiDAR point cloud, the system 500 may conduct pass through the neural network 2-dimensional “slices” or portions of the point cloud. One mechanism to transform point clouds into such 2-dimenstional portions is the PointPillars approach. As another example, where the sensor data 502a is a camera image from a given perspective (e.g., ground level) and the annotations 502b provide data of a different perspective (e.g., birds-eye view) the system 500 may project the annotations 502b onto the sensor data 502a to harmonized these inputs. For example, based on a known location and direction of the camera, the system 500 may project a traffic path indicated by the unvalidated annotations 502b onto the camera’s image. This projected path may then be concatenated with the image, such as by acting as an additional layer to the image. This concatenated image can then be used to facilitate identification of traffic paths within the image.

The concatenated image 504 can then be fed into a semantic annotation neural network 506 as, e.g., training, test, and/or validation data sets. The neural network 506 may illustratively be a convolutional neural network, such as the network 440 described above with reference to FIGS. 4C and 4D. In one embodiment, the neural network 506 is a “U-net” style neural network, which convolutional layers form both a contracting path (which downsamples information, such as via pooling operations) and an expansive path, via which the output of the contracting path is upsampled, potentially to the same dimensionality as inputs to the network. While neural networks are shown in FIG. 5, other types of machine learning networks may also be used. While a single concatenated image 504 is shown in FIG. 5, a large number of such images 504 may be provided to the network 506. For example, the system 500 can be provided with sensor data 502a for a number of locations within a wide geographic area (e.g., spanning tens, hundreds, or thousands or miles), and corresponding annotations 502b for such locations. Illustratively, an area may be divided (e.g., tokenized) into a number of regions of similar size, with sensor data 502a and unvalidated annotations 502b for each region being passed through the network 506 for training.

To facilitate training of the network 506, the system 500 also provides validated annotations 508. Validated annotations 508 illustratively represent known valid annotations for sensor data. For example, the validated annotations 508 may represent sensor data that has been manually annotated to provide semantic understanding, and validated through a sufficiently rigorous validation such that the validated annotations 508 can be used as “ground truth.” As shown in FIG. 5, the validated annotations may represent a “painting” of the sensor data 502a to indicate semantic understanding of the content of that data 502a. For example, specific areas of a birds-eye view may can be designated as crosswalks, intersections, traffic paths, etc.

In FIG. 5, each validated annotations 508 represents a geographic area aligned to the concatenated image 504. Thus, the validated annotations 508 may be used as labeled dataset usable to train the semantic annotation neural network 506. The system 500 may thus train the network 506 on the sensor data 502a, unvalidated annotations 502b, and validated annotations 508, to result in a trained ML model 510. Training of an ML model, in brief, can include passing the sensor data 502a and unvalidated annotations 502b through the network 506a and determining weights applied to those inputs such that an output of the network sufficiently corresponds to an expected result (e.g., the validated annotations 508). As will be appreciated by one skilled in the art, a result of generating the trained ML model 510 is that unlabeled data can then be passed through the model to predict one or more labels for that unlabeled data. More specifically, in accordance with embodiments of the present disclosure, these labels may represent predicted physical features within the data. Thus, by application of the trained ML model 510 to additional sensor data 502a and unvalidated annotations 502b, predicted semantic annotations for that sensor data 502a can be obtained.

With reference to FIG. 6, illustrative interactions will be described for using a trained ML model (such as that generated via the interactions of FIG. 5) to generate predicted semantic annotations for a geographic area. The interactions of FIG. 6 may in some instances be referred to as machine learning “inference.” The interactions are illustratively implemented by a perception system 402, which as noted above may be included within a vehicle 102. Thus, the interactions of FIG. 6 may be used, for example, to provide a vehicle with semantic understanding of the world around it, enabling a system (e.g., autonomous vehicle compute 202f) to perform such functions as planning of routes 106b, determining a location of the vehicle 102 within an area, etc.

The interactions of FIG. 6 are similar to FIG. 5, in that they relate to passing sensor data 502a and unvalidated annotations 502b through a neural network. For example, because the neural network 602 has been trained to operate on concatenated images 504 as discussed above, the perception system 402 can be configured to generate concatenated images 504 in substantially the same manner as discussed above with respect to FIG. 5. However, unlike FIG. 5, the interactions of FIG. 6 relate to use of a trained neural network 506, and thus do not require validated annotations 508 as inputs. Instead, application of the trained neural network 506 to the sensor data 502a and unvalidated annotations 502b results in generation of predicted annotations 604. For example, given sensor data representing a birds-eye view of an area and annotations indicating, for example, where roads, intersections, traffic signals, etc., are within the area, the perception system 402 can produce predicted annotations 604 that indicate, e.g., what portions of the sensor data 502a represent such roads, intersections, traffic signals, etc.

In some cases, the predicted annotations may be substantially similar to the unvalidated annotations 502b. However, as discussed above, the unvalidated annotations 502b may be considered unreliable, and thus unsuitable for direct use by the perception system 402. Because machine learning models are highly resilient to “noisy” data, passing the unvalidated annotations 502b through the trained ML model (that is, the trained semantic annotation neural network 602) can result in predicted annotations of much higher reliability than the unvalidated annotations 502b. For example, the trained ML model may enable the system 402 to cull invalid annotations within the unvalidated annotations 502b. Moreover, the ML model may enable more accurate alignment of unvalidated annotations 502b with sensor data 502a. For example, where annotations are effectively dimensionless with respect to sensor data 502a (e.g., as an indication of a number of lanes in a traffic path, without identification of where such lanes exist), use of a trained ML model can enable those annotations to be applied to sensor data 502a such that they are transformed into annotations with corresponding dimensions to the sensor data (e.g., specific portions of an image that represent each lane of a traffic path).

While FIG. 6 shows a specific example of annotations 604—“painting” of an image to indicate features—other annotation types are possible. For example, annotations 604 may be represented as bounding boxes, coloration, or simply raw data identifying the predicted physical features of sensor data 502a.

Accordingly, the predicted annotations 604 can provide substantial additional information to the perception system 402. In some cases, the predicted annotations 604 may be of sufficient reliability to be used as ground truth data for the system 402. Because unvalidated annotations 502b may be substantially more available than validated annotations 508 (which, as noted above, may be laborious to generate), use of a trained ML model as noted in FIG. 6 can substantially increase the ability of a perception system 402 to have semantic understanding of real world data. In turn, an improved perception system 402 may result, for example, in improved operation of a vehicle 102 to conduct self-driving operations.

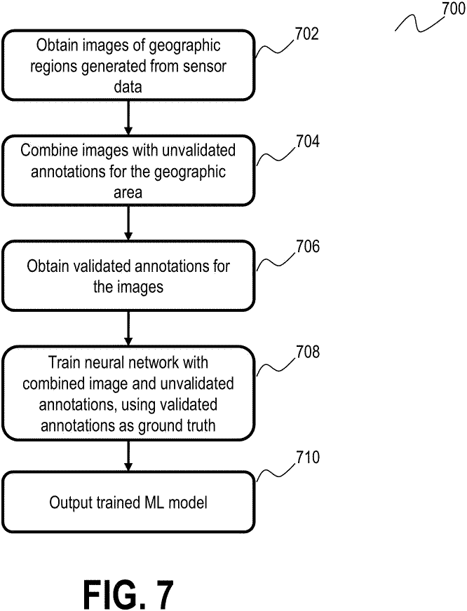

With reference to FIG. 7, an illustrative routine 700 will be described for generating a trained ML model to provide predicted semantic annotations based on inputs including sensor data and unvalidated semantic annotations. The routine 700 may be implemented, for example, by the training system 500 of FIG. 5.

The routine 700 begins at block 702, where the system 500 obtains an image of a geographic region generated from sensor data. As discussed above, the sensor data may represent a variety of types of data, such as LiDAR data, camera data, radar data, etc. This data may then be transformed into an n-dimensional image, such as a 3-d point cloud, a 2-d ground level image, a 2-d bird’s eye view map, etc. The image is illustratively associated with metadata that indicates information used to pair the image with unvalidated annotations. For example, metadata may include a type of the image (e.g., point cloud, ground level image, bird’s eye view map), a location of the image (e.g., as GPS coordinates or other location data), a scale of the image, a perspective of the image, etc. The images may illustratively be obtained for the purposes of creating an ML model. For example, a vehicle 102 may be used to gather sensor data 502a representing the images from a variety of known locations for the purposes of training the model.

At block 704, the images are combined with unvalidated annotations for the geographic area. Illustratively, for each image, the system 500 may obtain unvalidated annotations and concatenate a representation of the unvalidated annotations to the image. As noted above, the unvalidated annotations may be a portion of a data set, such as a publicly available data set. In some instances, the system 500 may be pre-populated with the data set. In other instances, the data set may be network-accessible, and thus the system 500 may obtain appropriate annotations for each image (e.g., for a given area represented within the image). As noted above, the system 500 may transform the unvalidated annotations as appropriate for the images. Illustratively, where the images represent birds-eye views, the system 500 may utilize a graph provided within the data set (e.g., of roads) to generate image layers representing, for example, traffic paths, intersections, cross walks, signage, signals, etc. These layers may then be concatenated to a corresponding image generated from sensor data. As discussed above, the image layers may in some cases be pre-processed, such as by applying blurring, distance maps, or other image transformations in order to ensure sufficient weight is given to the data within the layers. As another illustration, where the sensor-data-derived images are of different dimensionality of perspective than the unvalidated annotations, the system 500 may transform or project the annotations onto the images. For example, the system may project birds-eye view data of unvalidated annotations (e.g., the presence of a given physical feature in a given location) onto the sensor-data-derived images, and concatenate that projection to the image as an additional layer of the image.

At block 706, the system 500 obtains validated annotations for the images. For example, the system 500 may pass the images to human operators, who “mark up” the images with physical features shown in the images, thus providing semantic understanding of the images. Illustratively, the operators may designate portions of each image as having one or more physical features indicated within the unvalidated annotations, such as traffic paths (including a type of path, e.g., car, bike, pedestrian, etc.), intersections, cross walks, traffic signals, traffic signs, and the like. These validated annotations illustratively act as labels for the images, such that a machine learning model can be trained to add labels to subsequent images on the basis of unvalidated annotations.

Accordingly, at block 708, the system 500 trains a neural network machine learning model with the combined images and unvalidated annotations as inputs, using the validated annotations as ground truth. As noted above, training can include passing the combined images and unvalidated annotations through a variety of transformations (e.g., convolutions) that act to isolate specific features of the images. During training, these features can be compared to the validated annotations to identify whether they have been correctly identified. Through the general operation of training, the transformations can be modified, such as by modifying the weights applied at each transformation, such that the features output by the network approximate the features identified within the validated annotations. In this way, the network is trained to produce predicted features on the basis of unvalidated annotations. This trained model is then output at block 710.

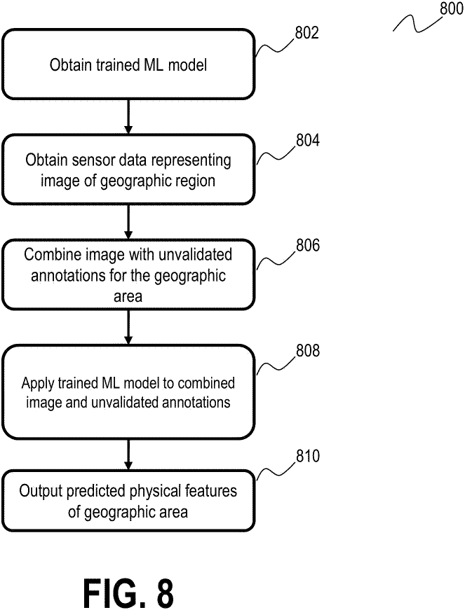

As noted above, the trained model may thereafter be used to provide predicted annotations on the basis of new sensor-data-based images and unvalidated annotations. One illustrative routine 800 for provide such predicted annotations is shown in FIG. 8. The routine 800 of FIG. 8 may be implemented, for example, by the perception system 402 of FIG. 4, which as noted above may be included within a vehicle 102. The routine 800 illustratively conducts inference operations against the trained model.

The routine 800 begins at block 802, where the perception system 402 obtains a trained ML model. The model may be generated, for example, via the routine 700 of FIG. 7. As discussed there, the model may be trained to take as input an image and associated unvalidated annotations and to provide as output predicted annotations for the image, representing semantic understanding of physical features shown in the image.

At block 804, the perception system 402 obtains sensor data representing an image of a geographic region. For example, the image may be a birds-eye view of an area around a vehicle 102, a ground-level view from a camera on the vehicle 102, a point cloud generated based on LiDAR sensors on the vehicle 102, etc. In one embodiment, the ML model is trained on a given class of data (e.g., a point cloud, a ground level image, a birds-eye view, etc.), and the sensor data obtained at block 804 corresponds to that class of data.

At block 806, the perception system 402 combines the image with unvalidated annotations for the geographic area. Illustratively, the system 402 may be pre-loaded with or have network access to a data set of unvalidated annotations, which annotations are provided for a variety of locations. The system 402 may determine a current location of the system 402 (e.g., using the localization system 406), and obtain unvalidated annotations for that location. The system 402 can then concatenate the image with the unvalidated annotations, in a similar manner to block 704 of FIG. 7, discussed above. As noted above, the system 402 may conduct preprocessing or pre-validation for the unvalidated annotations, such as by transforming or projecting the annotations into dimensions and a perspective of the image.

At block 808, the perception system 402 applies the trained ML model to the combined image and unvalidated annotations. As noted above, the trained ML model can generally represent a set of transformations (e.g., convolutions) that takes as input a combination of a sensor-data-derived image and unvalidated annotations, and passes as output predicted annotations for the input. The specific transformations have been determined during training to result in outputs that approximate “ground truth” (e.g., validated inputs against which the model has trained). Thus, at block 810, the trained ML model outputs predicted physical features of the geographic area, providing semantic understanding of the sensor-data-derived image. Given the ML model’s resilience to “noise” in data, these predicted features are expected to be of higher accuracy than the unvalidated annotations alone. Accordingly, implementation of the routine 800 of FIG. 8 can enable accurate predictions of physical features even based on potentially inaccurate annotations. Moreover, the routine 800 is not limited to being implemented in geographic areas where validated ground truth exists, but can exist in a wider variety of locations associated with unvalidated annotations. Accordingly, the routine 800 can enable accurate perception from sensor data in a larger area than might otherwise be possible. This, in turn, leads to advancement in a wide variety of functions, such as route planning for autonomous vehicles.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method, comprising:
obtaining, with at least one processor, sensor data representing an image of a geographic area;
obtaining, with the at least one processor, data representing unvalidated annotations for the geographic area providing a semantic understanding, of physical features within the geographic area, that is unvalidated;
obtaining, with the at least one processor, data representing validated annotations for the geographic area providing a semantic understanding, of the physical features within the geographic area, that is validated; and
training, with the at least one processor, a neural network using the sensor data and unvalidated annotations for the geographic area as an input and the validated annotations for the geographic area as a ground truth, wherein training the neural network results in a trained machine learning (ML) model.

2. The method of claim 1, further comprising:
obtaining second sensor data representing an image of a second geographic area;
obtaining second unvalidated annotations, the second unvalidated annotations corresponding to the second geographic area, wherein the second unvalidated annotations provide a semantic understanding of physical features within the second geographic area that is unvalidated; and
applying the trained ML model to the second sensor data and the second unvalidated annotations to produce output data indicating predicted physical features of the second geographic area.

3. The method of claim 2, wherein training the neural network comprises training the neural network on a first computer, and wherein applying the trained ML model to the second sensor data comprises applying the trained ML model to the second sensor data on a second computer different from the first computer.

4. The method of claim 3, wherein the second computer is included within a motorized vehicle, the method further comprising:
using the predicted physical features to determine a present location of the motorized vehicle.

5. The method of claim 3, wherein the second computer is included within a motorized vehicle, the method further comprising using the predicted physical features to determine a movement path for the motorized vehicle.

6. The method of claim 1, wherein the physical features comprise at least one of a drivable surface, an intersection, a crosswalk, a traffic sign, a traffic signal, a traffic lane, or a bike lane.

7. The method of claim 1, wherein the image of the geographic area comprises at least one of a birds-eye view image, a ground-level image, or a point cloud image.

8. The method of claim 1, wherein the unvalidated annotations for the geographic area represents crowd sourced annotations.

9. The method of claim 1, wherein using the sensor data and unvalidated annotations for the geographic area as an input comprises
concatenating the image of the geographic area and the unvalidated annotations into a multi-layered image of the geographic area.

10. The method of claim 1, wherein the unvalidated annotations for the geographic area comprises a graph, the graph comprising including edges representing drivable surfaces and nodes representing traffic intersections.

11. The method of claim 10, wherein using the sensor data and unvalidated annotations for the geographic area as an input comprises:
transforming the graph into raster data, and
wherein transforming the graph into raster data comprises:
generating intermediate raster data and applying geometric manipulations to the intermediate raster data to produce the raster data.

12. A system, comprising:
at least one processor, and
at least one non-transitory storage media storing instructions that, when executed by the at least one processor, cause the at least one processor to:
obtain sensor data representing an image of a geographic area;
obtain data representing unvalidated annotations for the geographic area providing a semantic understanding, of physical features within the geographic area, that is unvalidated;
obtain data representing validated annotations for the geographic area providing a semantic understanding, of the physical features within the geographic area, that is validated; and
train a neural network using the sensor data and unvalidated annotations for the geographic area as an input and the validated annotations for the geographic area as a ground truth, wherein training the neural network results in a trained machine learning (ML) model.

13. The system of claim 12, further comprising:
an additional processor; and
an additional non-transitory storage media storing second instructions that, when executed by the at least one processor, cause the additional processor to:
obtain second sensor data representing an image of a second geographic area;
obtain second unvalidated annotations, the second unvalidated annotations corresponding to the second geographic area, wherein the second unvalidated annotations provide a semantic understanding of physical features within the second geographic area that is unvalidated; and
apply the trained ML model to the second sensor data and the second unvalidated annotations to produce output data indicating predicted physical features of the second geographic area.

14. The system of claim 13, wherein the additional processor and additional non-transitory storage media are included within a motorized vehicle, and wherein the second instructions, when executed, further cause the additional processor to use the predicted physical features to determine a present location of the motorized vehicle.

15. The system of claim 13, wherein the additional processor and additional non-transitory storage media are included within a motorized vehicle, and wherein the second instructions, when executed, further cause the additional processor to use the predicted physical features to determine a movement path for the motorized vehicle.

16. The system of claim 12, wherein using the sensor data and unvalidated annotations for the geographic area as an input comprises:
concatenating the image of the geographic area and the unvalidated annotations into a multi-layered image of the geographic area.

17. At least one non-transitory storage media storing instructions that, when executed by a computing system comprising a processor, cause the computing system to:
obtain sensor data representing an image of a geographic area;
obtain data representing unvalidated annotations for the geographic area providing a semantic understanding, of physical features within the geographic area, that is unvalidated;
obtain data representing validated annotations for the geographic area providing a semantic understanding, of the physical features within the geographic area, that is validated; and
train a neural network using the sensor data and unvalidated annotations for the geographic area as an input and the validated annotations for the geographic area as a ground truth, wherein training the neural network results in a trained machine learning (ML) model.

18. The at least one non-transitory storage media of claim 17 further comprising second instructions that, when executed, cause the computing system to:
obtain second sensor data representing an image of a second geographic area;
obtain second unvalidated annotations, the second unvalidated annotations corresponding to the second geographic area, wherein the second unvalidated annotations provide a semantic understanding of physical features within the second geographic area that is unvalidated; and
apply the trained ML model to the second sensor data and the second unvalidated annotations to produce output data indicating predicted physical features of the second geographic area.

19. The at least one non-transitory storage media of claim 18, wherein the computing system comprises a motorized vehicle, and wherein the second instructions, when executed, further cause the computing system to use the predicted physical features to determine a movement path for the motorized vehicle.

20. The at least one non-transitory storage media of claim 17, wherein using the sensor data and unvalidated annotations for the geographic area as an input comprises:
concatenating the image of the geographic area and the unvalidated annotations into a multi-layered image of the geographic area.
